(19) United States
(12) Patent Application Publication
(10) Pub. No.: US 2015/0005980 A1
(43) Pub. Date: Jan. 1, 2015

(54) METHOD AND APPARATUS FOR CONTROLLING TEMPERATURE

(71) Applicant: Samsung Electronics Co., Ltd., Gyeonggi-do (KR)

(72) Inventors: Min-Soo KIM, Gyeongsangbuk-do (KR); Jung-Keun LEE, Seoul (KR); Ji-Woong OH, Gyeongsangbuk-do (KR)

(73) Assignee: Samsung Electronics Co., Ltd., Gyeonggi-do (KR)

(21) Appl. No.: 14/297,025

(22) Filed: Jun. 5, 2014

(30) Foreign Application Priority Data
Jun. 26, 2013 (KR) 10-2013-0073776

(51) Int. Cl. G05D 23/19

(52) U.S. Cl. CPC G05D 23/1917
USPC 700/300; 165/287

(57) ABSTRACT

A method of controlling a temperature of a terminal apparatus includes measuring a first temperature of a heat source area where at least one heat source is included in the terminal apparatus, and measuring a second temperature of an external area that is distant from the heat source area; determining a difference between the first temperature and the second temperature; and controlling heat generated from the heat source, based on the difference between the first temperature and the second temperature.

### PRIORITY

This application claims priority under 35 U.S.C. §119(a) to a Korean Patent Application filed in the Korean Intellectual Property Office on Jun. 26, 2013 and assigned Serial No. 10-2013-0073776, the entire content of which is incorporated herein by reference.

### BACKGROUND OF THE INVENTION

1. Field of the Invention

The present invention relates generally to a method and an apparatus for controlling heat generated by an apparatus.

2. Description of the Related Art

Recently developed mobile devices provide more diverse services and optional functions. To improve usefulness of the mobile device and meet users' different needs, various practical applications have been developed.

The mobile device may store and run default applications installed therein at a manufacturing stage and optional applications downloaded from application sales sites on the Internet. Optional applications may be developed by general developers and registered in the sales websites. Anyone can freely develop and sell his/her application through an application sales site to a user of the mobile device. Hundreds of thousands of free or paid applications are being provided for current mobile devices.

While a portable terminal apparatus processes various applications, operation performance or data storage performance of the portable terminal apparatus has been developed to provide high performance. Accordingly, because the operation performance or the data storage performance has been enhanced, a variety of methods of controlling heat generated by the performance from the portable terminal apparatus have been developed.

### SUMMARY OF THE INVENTION

The present invention has been made to address the problems and/or disadvantages described above, and to provide at least the advantages described below.

Accordingly, an aspect of the present invention is to provide a method and an apparatus for controlling a temperature of a portable terminal using a difference between a first temperature and a second temperature.

In accordance with an aspect of the present invention, a method of controlling a temperature of a terminal apparatus is provided. The method includes measuring a first temperature of a heat source area where at least one exothermic portable terminal is included in the terminal apparatus, and measuring a second temperature of an external area that is distant from the heat source area; determining a difference between the first temperature and the second temperature; and controlling heat generated from the heat source area, based on the difference between the first temperature and the second temperature.

In accordance with another aspect of the present invention, a terminal apparatus is provided. The terminal apparatus includes at least one processor, a first temperature sensor that measures a first temperature of a heat source area where an exothermic portable terminal including the at least one processor is contained; a second temperature sensor that measures a second temperature of an external area that is distant from the heat source area; a memory that stores at least a temperature control program; and a terminal housing that includes the exothermic portable terminal including the at least one processor, the first temperature sensor, and the memory, wherein the temperature control program is operated by the at least one processor, and includes an instruction that controls heat generated from the heat source area based on a difference between the first temperature and the second temperature.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a schematic block diagram illustrating a portable terminal apparatus to which a temperature control method is applied according to an embodiment of the present invention;

FIG. 2 is a diagram illustrating a schematic configuration of a portable terminal apparatus to which a temperature control method is applied according to an embodiment of the present invention;

FIG. 3 is a diagram illustrating a schematic configuration of a portable terminal apparatus to which a temperature control method is applied according to an embodiment of the present invention;

FIG. 4 is a flowchart illustrating a temperature control method according to a first embodiment of the present invention;

FIG. 5 is a flowchart illustrating a temperature control method according to a second embodiment of the present invention; and

FIG. 6 is a flowchart illustrating a temperature control method according to a third embodiment of the present invention.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various details to assist in that understanding but these are to be regarded as merely examples. Accordingly, those of ordinary skilled in the art will recognize that various changes and modifications of the embodiments described herein can be made without departing from the scope and spirit of the invention. In addition, descriptions of constructions or processes known in the art may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

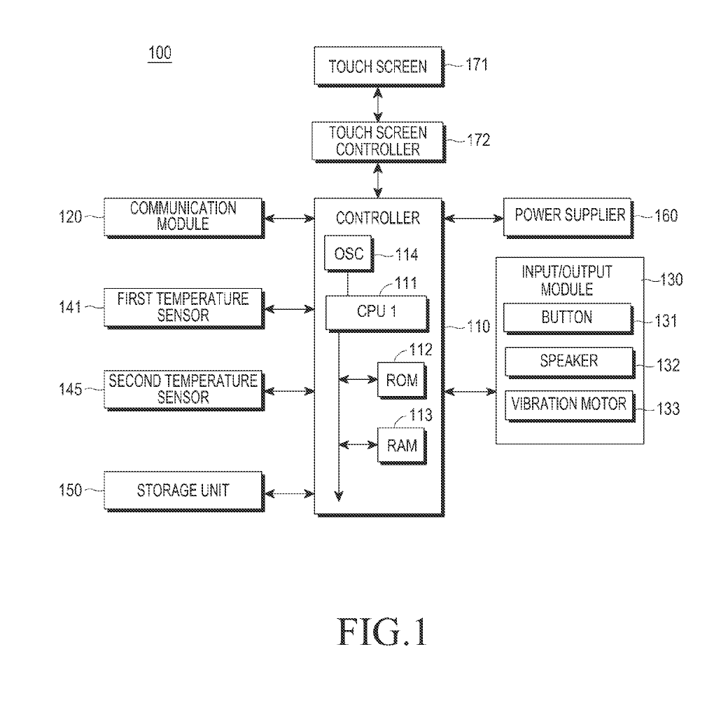

FIG. 1 illustrates a portable terminal according to an exemplary embodiment of the present invention. Referring to FIG. 1, a portable terminal 100 may include a controller 110, a first temperature sensor 141, a second temperature sensor 145, a storage unit 150, and a power supplier 160.

The controller 110 may include a Central Processing Unit (CPU) 111, a Read Only Memory (ROM) 112 storing a control program for controlling the device 100, and a Random Access Memory (RAM) 113, which temporarily stores signals or data received from the outside of the device 100, or is used as a storage area for the operations performed in the device 100. The CPU 111, ROM 112 and RAM 113 may be interconnected via an internal bus.

The controller 110 may control the first temperature sensor 141, the second temperature sensor 145, the storage unit 150, and the power supplier 160. The controller 110 may be comprised of a single core or multiple cores such as dual cores, triple cores, and quad cores. It will be apparent to those of ordinary skill in the art that the number of cores is subject to change depending on the characteristics of the terminal.

The communication module 120 may include at least one of the following: a cellular module, a Wireless Local Area Network (WLAN) module, and a short-range communication module.

The cellular module is configured to connect the device 100 to the external device for mobile communication via at least one or more antennas, under the control of the controller 110. The cellular module exchanges wireless signals for voice calls, video calls, Short Message Service (SMS) messages and/or Multimedia Messaging Service (MMS) messages, between the device 100 and cellular phones, smart phones, tablet Personal Computers (PCs), or other devices, of which phone numbers are stored or registered in the device 100.

The WLAN module may be connected to the Internet in the place where a wireless Access Point (AP) (not shown) is installed, under the control of the controller 110. The WLAN module supports the WLAN standard (IEEE802.11x) defined by Institute of Electrical and Electronics Engineers (IEEE). The WLAN module may drive the Wi-Fi Positioning System (WPS) that identifies location information of the terminal device, using the location information provided by a wireless AP to which the WLAN module is wirelessly connected.

The short-range communication module may wirelessly handle short-rang communication such as Bluetooth, Infrared Data Association (IrDA), WiFi-Direct, and Near Field Communication (NFC), under the control of the controller 110.

The I/O module 130 may include at least one of a button 131, a speaker 132, and a vibration motor 133.

The button 131 may be formed on the front, side and/or rear of the housing of the device 100, and may include at least one of a power/lock button, a volume button, a menu button, a home button, a back button, and a search button.

The speaker 132 may output the sounds corresponding to various signals (for example, wireless signals, broadcast signals, and the like) from the cellular module, the WLAN module and the short-range communication module, to the outside of the device 100, under the control of the controller 110. One or multiple speakers 132 may be formed in one or multiple proper positions of the housing of the device 100.

The vibration motor 133 may convert electrical signals into mechanical vibrations under the control of the controller 110. One or multiple vibration motors 133 may be formed in the housing of the device 100.

The speaker 132 and the vibration motor 133 may operate depending on the set state of the volume operating mode of the device 100.

The storage unit 150 may store a variety of applications and a control program for control of the device 100 or the controller 110.

The term ‘storage’ as used herein may include the storage unit 150, the ROM 112 and RAM 113 in the controller 110, and a memory card (for example, a Secure Digital (SD) card, a memory stick) mounted in the device 100. The storage may include a non-volatile memory, a volatile memory, a Hard Disk Drive (HDD), a Solid State Drive (SSD), and the like.

The power supplier 160 may supply the power to one or multiple rechargeable batteries mounted in the housing of the device 100, under the control of the controller 110. The one or multiple batteries supply power to the device 100. The power supplier 160 may supply the power received from the external power source to the device 100 through a wired cable that is connected to a connector mounted in the device 100. The power supplier 160 may supply the power that is wirelessly received from the external power source by wireless charging technology, to the device 100.

The portable terminal 100 may include a touch screen 171 and a touch screen controller 172.

The touch screen 171 may display User Interfaces (UIs) corresponding to various services (for example, calls, data transmission, and the like) for the user, based on the terminal's Operation System (OS). The touch screen 171 may transfer an analog signal corresponding to at least one touch entered on a UI, to the touch screen controller 172. The touch screen 171 may receive at least one touch input through the user's body (for example, fingers including the thumb) and/or by a touch input means (for example, a stylus pen). The touch screen 171 may receive a continuous movement input of at least one touch. The touch screen 171 may transfer an analog signal corresponding to a continuous movement of an input touch, to the touch screen controller 172. The touch screen 171 may be implemented in, for example, a resistive type, a capacitive type, an infrared type, or an acoustic wave type.

The touch screen controller 172 controls output values of the touch screen 171 so that the display data provided by the controller 110 are displayed on the touch screen 171.

The touch screen controller 172 converts analog signals received from the touch screen 171 into digital signals (for example, X/Y coordinates) and transfers them to the controller 110. The controller 110 may control the touch screen 171 using the digital signals received from the touch screen controller 172. For example, in response to a touch event or a hovering event, the controller 110 may select or execute a related shortcut icon displayed on the touch screen 171. The touch screen controller 172 may be incorporated into the controller 110.

According to an embodiment of the present invention, the portable terminal 100 may utilize various control programs and applications, and may have a high operation processing capability and a high data storage capability. Thus, heat generated from the portable terminal 100 may make the user feel uncomfortable in using the portable terminal apparatus 100, cause a safety hazard to a user, or damage a part of the portable terminal apparatus 100. Therefore, a storage unit 150 may store a temperature control program including instructions for controlling heat generated from the portable terminal apparatus 100, and a controller 110 may control heat generated from the portable terminal apparatus 100 based on an instruction included in the temperature control program of the portable terminal apparatus 100.

In addition, although heat is generated from the portable terminal apparatus 100, the user's feeling may depend on the temperature difference between a heat source area in the portable terminal apparatus 100 and an external area in the portable terminal apparatus 100 that is not affected by the heat generated from the heat source area. For example, the user may feel uncomfortable in using the portable terminal apparatus 100 when the temperature difference between the heat source area and the external area is large, while the user may not feel uncomfortable in using the portable terminal apparatus 100 when the temperature difference between the heat source area and the external area is small, although the temperature in the heat source area is identical.

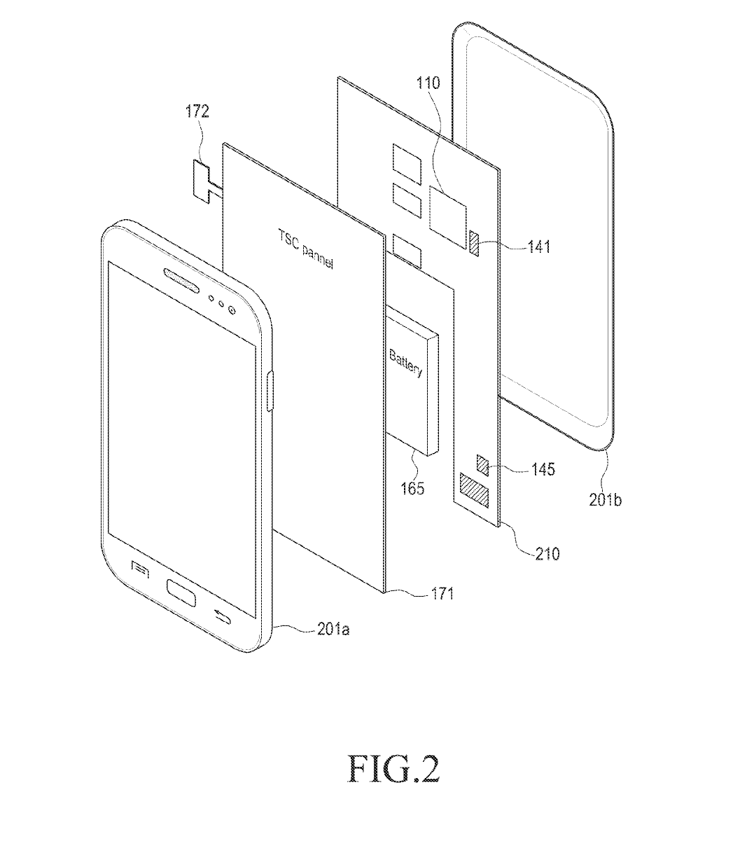

FIG. 2 is a diagram illustrating a schematic configuration of a portable terminal apparatus according to an embodiment of the present invention. Referring to FIG. 2, the portable terminal apparatus 100 controls heat generated from the portable terminal apparatus 100 corresponding to the difference between temperature values measured by a first temperature sensor 141 and a second temperature sensor 145. Here, the first temperature sensor 141 monitors a temperature of a heat source area where an exothermic portable terminal that generates a large amount of heat in the portable terminal apparatus 100 is included. For example, the first temperature sensor 141 may be equipped with a circuit including a thermister that measures a value in an analog format and an Analog to Digital Converter (ADC) that converts the measured analog value into a digital value, and outputs the digital value. The first temperature sensor 141 is placed close to the hear source, for example, a CPU 111, an oscillator 114, and the like, that generates a large amount of heat in the portable terminal apparatus 100.

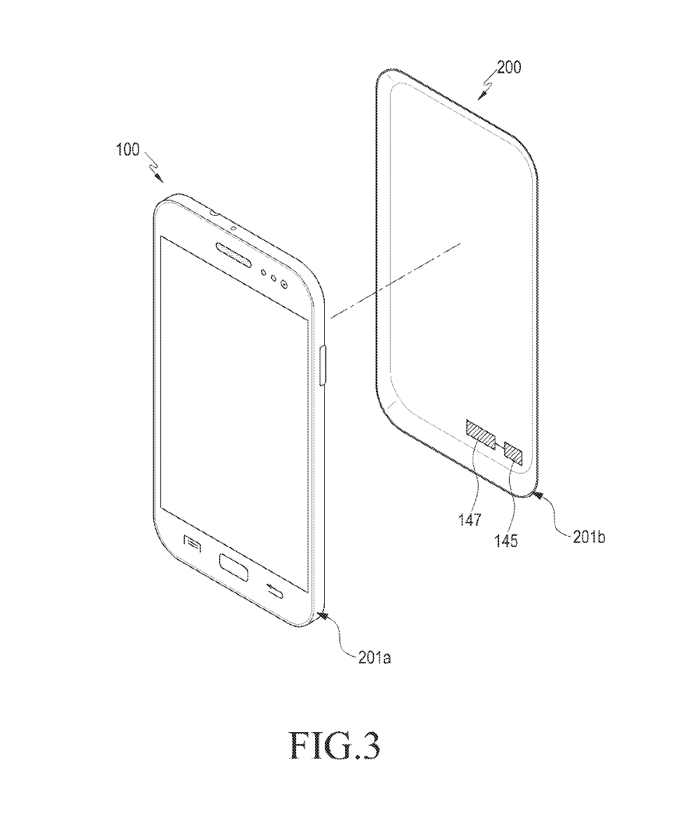

The second temperature sensor 145 monitors a temperature in an ambient environment of the portable terminal apparatus 100. For example, the second temperature sensor 145 may be equipped with a circuit including a thermister that measures a value in an analog format and an ADC that converts the measured value into a digital value, and outputs the digital value. The second temperature sensor 145 may be placed in an external area in the portable terminal apparatus 100 that is not affected by the heat generated from the heat source area. For example, when the CPU 111, the oscillator 114, the first temperature sensor 141, and the like are placed in an upper portion of a circuit substrate 210, the second temperature sensor 145 may be placed in a lower portion of the circuit substrate 210. FIG. 3 is a diagram illustrating a schematic configuration of a portable terminal according to an embodiment of the present invention. Referring to FIG. 3, the second temperature sensor 145 may not be contained in the inside of the portable terminal apparatus 100 and may be placed in an external case 200 of the portable terminal apparatus 100. For example, the external case 200 may enclose a portion of an entirety housing 201a and 201b. As described above, when the second temperature sensor 145 is placed in the external case 200 of the portable terminal apparatus 100, the temperature in an ambient environment of the portable terminal apparatus 100 is measured and output as a digital value. The digital value is provided to a controller 110 of the portable terminal apparatus 100 through a communication interface 147 by wire or wirelessly.

According to embodiments of the present invention, hereinafter, methods embodied as a program can be executed through various computer means, and can be recorded in a computer-readable recording medium. The computer-readable recoding medium may contain program commands, data files, data structures, or the like, individually or in combination. The program recorded in the medium may be specially designed for the present invention or publicly known and used by a person skilled in the art of computer software.

According to embodiments of the present invention, the methods embodied as a program may be stored in storage unit 150 in the portable terminal apparatus 100. The program command may be temporarily stored in RAM 113 in the controller 110 so as to execute the methods. Accordingly, the controller 110 performs a control on hardware components included in the portable terminal apparatus 100 in response to the program command associated with the methods, stores the generated data temporarily or continuously in the storage unit 150, when the methods are executed, and provides, a user interface (UI) required for execution of the methods to a touch screen controller 172.

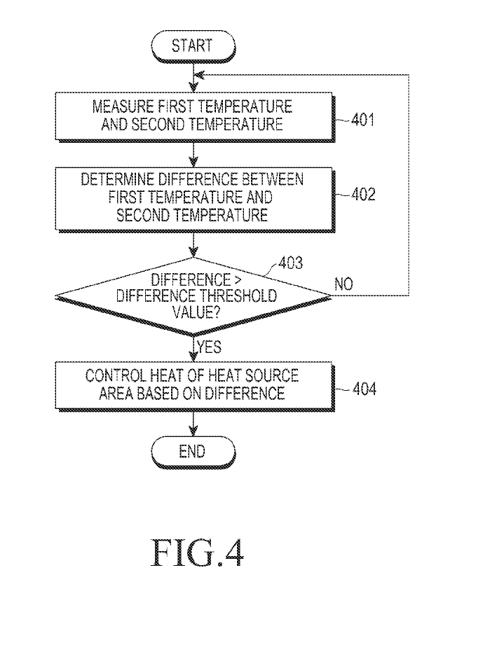

FIG. 4 is a flowchart illustrating a temperature control method according to a first embodiment of the present invention.

Referring to FIG. 4, the controller 110 instructs the first temperature sensor 141 and the second temperature sensor 145 to operate, and receives a first temperature measured by the first temperature sensor 141 and a second temperature measured by the second temperature sensor 145 in step 401.

The operation instruction for the first temperature sensor 141 and the second temperature sensor 145 may be generated based on initiation of an operation of the portable terminal apparatus 100, or based on a predetermined time unit, or based on initiation of an operation of a predetermined application (for example, an application that requires many calculation operations).

The first temperature sensor 141 monitors a temperature of a heat source area that generates a large amount of heat in the portable terminal apparatus 100, and is disposed close to the heat source area that generates a large amount of heat (for example, the CPU 111, the oscillator 114, and the like) so as to measure a temperature of heat generated from the heat source area, that is, the first temperature of the portable terminal apparatus 100. The second temperature sensor 145 monitors a temperature of an ambient environment of the portable terminal apparatus 100, and is disposed in an external area that is distant from a heat source area so that the measurement is not affected by the heat source area that generates a large amount of heat, to measure a temperature of the external area of the portable terminal apparatus 100, that is, the second temperature of the portable terminal apparatus 100.

In step 402, the controller 110 calculates a difference between the first temperature and the second temperature. For example, the controller 110 may calculate the difference between the first temperature and the second temperature that are input after being converted into digital values.

In step 404, the controller 110 controls an operation of the heat source area that generates a large amount of heat so that the exothermic portable terminal generates a relatively small amount of heat, by taking the difference between the first temperature and the second temperature into consideration.

For example, controlling the operation of the heat source area may include controlling a clock in a baseband of the communication unit 120, controlling generation of a clock of the oscillator 114 that supplies a clock signal to the CPU 111, controlling a process of an application driven by the controller 110, or the like. Although controlling the operation of the above components is described above, the present invention may not be limited thereto. It is apparent that controlling the operation of the heat source area may be variously modified by those skilled in the art.

Although the difference between the first temperature and the second temperature may exist in a range in which the user does not feel inconvenience, the user may feel uncomfortable when the difference between the first temperature and the second temperature is out of the range.

Therefore, before proceeding to step 404, the controller 110 may further perform an operation of determining whether the difference between the first temperature and the second temperature exceeds a predetermined difference threshold value, by taking the level in which the user feels uncomfortable in using the apparatus into consideration, in step 403. The controller 110 proceeds to step 404 when the difference between the first temperature and the second temperature exceeds the difference threshold value and thus, may control an operation of a heat source area contained in the portable terminal apparatus 100, for example, the CPU 111, the oscillator 114, the communication module 120, and the like.

When the difference between the first temperature and the second temperature exceeds the difference threshold value, the user may feel uncomfortable, and thus, the controller 110 proceeds to an operation of lowering a temperature of the heat source area by giving priority consideration to necessary operations performed in the portable terminal (for example, the CPU 111, the oscillator 114, the communication module 120, and the like). For example, the controller 110 may not control a clock in a baseband of the communication unit 120, a clock of the oscillator 114 that supplies a clock signal to the CPU 111, or the like, and may perform a control on only a process of a predetermined application that has been driven by the controller 110.

Moreover, the controller 110 may set the difference threshold value in stages to control the operation of the portable terminal. For example, the controller 110 may set a first difference threshold value and a second difference threshold value (a relatively larger value than the first threshold value), and may control the operation of the portable terminal based on whether the difference between the first temperature and the second temperature exceeds the first difference threshold value or the second difference threshold value. When the difference between the first temperature and the second temperature exceeds the first difference threshold value, the controller 110 may not control the clock in the baseband of the communication unit 120, the clock of the oscillator 114 that supplies the clock signal to the CPU 111, or the like, and may perform a control on only a process of a predetermined application that has been driven by the controller 110. When the difference between the first temperature and the second temperature exceeds the second difference threshold value, the controller 110 may perform all operations, such as controlling the clock in the baseband of the communication unit 120, controlling the clock of the oscillator 114 that supplies the clock signal to the CPU 111, and controlling a process of a predetermined application that has been driven by the controller 110.

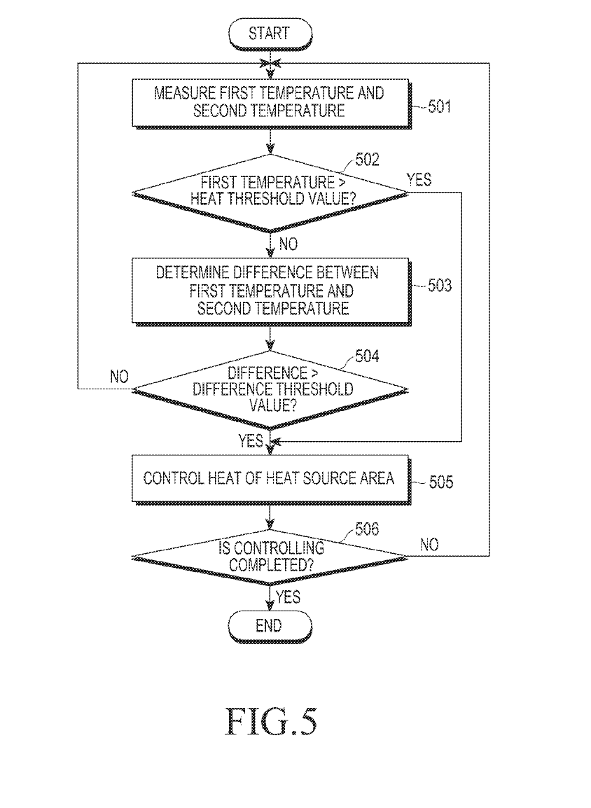

FIG. 5 is a flowchart illustrating a temperature control method according to a second embodiment of the present invention.

An operation sequence of a temperature control method according to the second embodiment of the present invention is similar to that of the temperature control method according to the first embodiment of the present invention. The temperature control method according to the second embodiment of the present invention operates to prevent a temperature of a heat source area measured by the first temperature sensor 141 from an excessive increase and reaching a level in which a user may feel uncomfortable or may be harmed, a level in which the heat source contained in the portable terminal apparatus 100 is damaged, or a level in which the portable terminal malfunctions.

The temperature control method according to the second embodiment of the present invention may further proceed to an operation of determining whether the first temperature measured on the heat source area exceeds a heat threshold value so as to prevent an excessive increase in a temperature of the heat source area measured by the first temperature sensor 141.

Referring to FIG. 5, the controller 110 instructs the first temperature sensor 141 and the second temperature sensor 145 to operate, and receives a first temperature measured by the first temperature sensor 141 and a second temperature measured by the second temperature sensor 145, in step 501.

The operation instructions for the first temperature sensor 141 and the second temperature sensor 145 may be generated based on initiation of an operation of the portable terminal apparatus 100, or based on a predetermined time unit, or based on initiation of an operation of a predetermined application (for example, an application that requires many calculation operations).

The first temperature sensor 141 monitors a temperature of the heat source area where an exothermic portable terminal that generates a large amount of heat in the portable terminal apparatus 100 is included (for example, the CPU 111, the oscillator 114, the communication module 120, and the like), and measures the first temperature of the portable terminal apparatus 100.

The second temperature sensor 145 monitors a temperature of an ambient environment of the portable terminal apparatus 100, The second temperature sensor 145 is placed in an external area that is distant from the heat source area so that the measurement is not affected by the heat source (for example, the CPU 111, the oscillator 114, and the like) that generates a large amount of heat, and measures the second temperature of the portable terminal apparatus 100.

The controller 110 determines whether the first temperature exceeds a predetermined threshold value (hereinafter, a heat threshold value) in step 502. Step 502 is performed to prevent an excessive increase in a temperature of the heat source area measured by the first temperature sensor 141, and the heat threshold value may be set by considering a temperature level in which a safety hazard to a user may occur, a temperature level in which the heat source contained in the portable terminal apparatus 100 is damaged, or a temperature level in which the portable terminal apparatus 100 malfunctions.

When the first temperature exceeds the heat threshold value, the controller 110 proceeds to step 505. When the first temperature does not exceed the heat threshold value, the controller 110 proceeds to step 503.

In step 503, the controller 110 calculates a difference between the first temperature and the second temperature. For example, the difference between the first temperature and the second temperature may be calculated by subtracting the second temperature from the first temperature, which are input after being converted into digital values.

In step 504, the controller 110 determines whether the difference between the first temperature and the second temperature exceeds a predetermined threshold value (hereinafter, referred to as “difference threshold value”). The difference threshold value may be set based on a level (for example, 15° C.) in which the user may feel uncomfortable in using the portable terminal apparatus 100 due to a difference between a temperature (the first temperature) of the heat source area and a temperature (the second temperature) of the external area. When the difference between the first temperature and the second temperature exceeds the difference threshold value, the controller 110 proceeds with to 505.

When the difference between the first temperature and the second temperature does not exceed the difference threshold value, the difference between the first temperature and the second temperature is maintained in a range where the user does not feel uncomfortable in using the portable terminal apparatus 100, and thus, the controller 110 may not separately control an operation of the heat source contained in the portable terminal apparatus 100, and may proceed to a process that repeatedly performs the operations described above (steps 501, 502, and 503), in step 504.

In step 505, the controller 110 may control an operation to lower heat generated from the heat source (for example, the CPU 111, the oscillator 114, the communication module 120, and the like). For example, the controller 110 may control a clock in a baseband of the communication unit 120, may control generation of a clock of the oscillator 114 that supplies a clock signal to the CPU 111, or may control a process of an application that has been driven by the controller 110, so as to control heat generated from the heat source area.

In addition, in step 505, the controller 110 may perform different operations when the first temperature exceeds the heat threshold value and when the difference between the first temperature and the second temperature exceeds the difference threshold value.

When the first temperature exceeds the heat threshold value, the user may be harmed, or the heat source may be damaged or malfunctions, and thus, the temperature of the heat source area may be relatively quickly lowered, when compared to a case in which the difference between the first temperature and the second temperature exceeds the difference threshold value. Therefore, when the first temperature exceeds the heat threshold value, the controller 110 preferentially processes the operation of lowering the temperature of the heat source area instead of other processes performed in the heat source (for example, the CPU 111, the oscillator 114, the communication module 120, and the like). Moreover, when the difference between the first temperature and the second temperature exceeds the difference threshold value, the user may feel uncomfortable in using the portable terminal apparatus 100, and thus, the controller 110 may proceed to an operation of lowering the temperature of the heat source area by giving priority consideration to necessary operations performed in the portable terminal (for example, the CPU 111, the oscillator 114, the communication module 120, and the like). For example, when the first temperature exceeds the heat threshold value, the controller 110 may perform all operations, such as controlling a clock in a baseband of the communication unit 120, controlling a clock of the oscillator 114 that supplies a clock signal to the CPU 111, controlling a process of a predetermined application that has been driven by the controller 110, and the like. When the difference between the first temperature and the second temperature exceeds the difference threshold value, the controller 110 may not control the clock in the baseband of the communication unit 120, the clock of the oscillator 114 that supplies the clock signal to the CPU 111, or the like, and may perform a control on a process of a predetermined application that has been driven by the controller 110.

In step 506, the controller 110 may repeatedly perform steps 501 through 505 until an operation of controlling a temperature is completed.

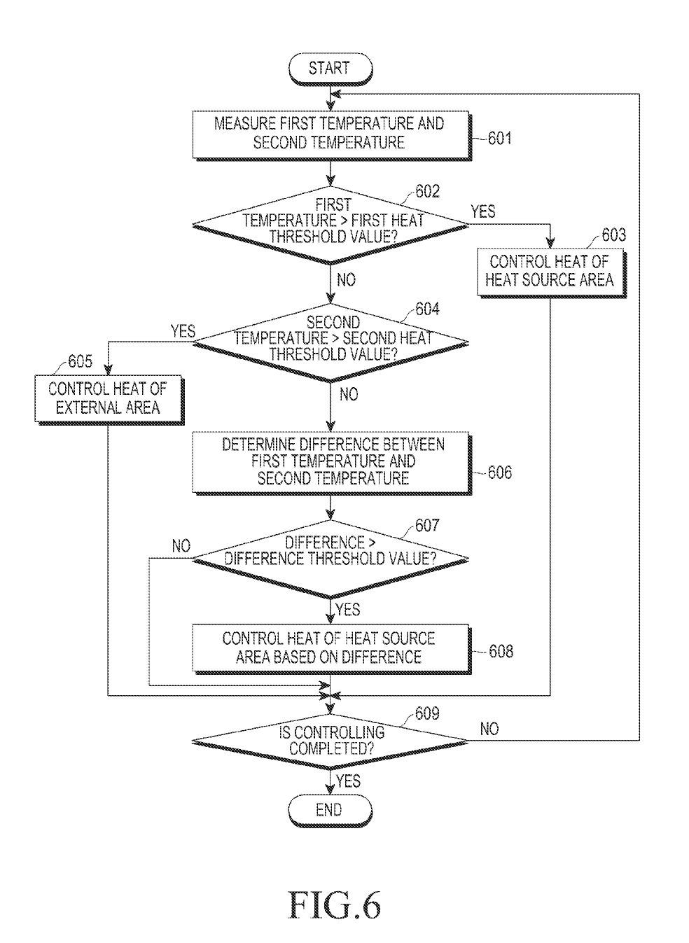

FIG. 6 is a flowchart illustrating a temperature control method according to a third embodiment of the present invention.

An operation sequence of the temperature control method according to the third embodiment of the present invention is similar to that of the temperature control method of the second embodiment of the present invention. A temperature of an external area measured by the second temperature sensor 145 may increase and reach a level in which a component of the portable terminal apparatus 100 (for example, an input/output module 130, a power supplier 160, and the like) in the external area of the heat source is damaged, a level in which the component malfunctions, or a level in which a user feels uncomfortable or may be harmed, and thus, similar to the temperature control method according to the second embodiment of the present invention, the temperature control method according to the third embodiment of the present invention further includes an operation of determining whether a second temperature measured by the second temperature sensor 145 exceeds a second heat threshold value, after determining whether a first temperature measured by the first temperature sensor 141 exceeds a first heat threshold value.

Referring to FIG. 6, the controller 110 instructs the first temperature sensor 141 and the second temperature sensor 145 to operate, and receives the first temperature measured by the first temperature sensor 141 and the second temperature measured by the second temperature sensor 145, in step 601.

The operation instruction for the first temperature sensor 141 and the second temperature sensor 145 may be generated based on initiation of an operation of the portable terminal apparatus 100, based on a predetermined time unit, or based on initiation of an operation of a predetermined application (for example, an application that requires many calculation operations).

The first temperature sensor 141 monitors a temperature of a heat source (for example, the CPU 111, the oscillator 114, the communication module 120, and the like) that generates a large amount of heat in the portable terminal apparatus 100, and measures a temperature of the heat source area, that is, the first temperature of the portable terminal apparatus 100.

The second temperature sensor 145 monitors a temperature of an ambient environment of the portable terminal apparatus 100, The second temperature sensor 145 is placed in an external area that is distant from the heat source area so that the measurement is not affected by heat generated from the heat source area (for example, the CPU 111, the oscillator 114, and the like) where a large amount of heat is generated, and measures a temperature of the external area, that is, the second temperature of the portable terminal apparatus 100.

The controller 110 determines whether the first temperature exceeds a predetermined threshold value (hereinafter, referred to as “first heat threshold value”) in step 602. Step 602 is performed to prevent an excessive increase in a temperature of the heat source area measured by the first temperature sensor 141, and the first heat threshold value may be set by considering a temperature level in which a safety hazard to a user may occur, a temperature level in which the heat source in the portable terminal apparatus 100 is damaged, or a temperature level in which the portable terminal apparatus 100 malfunctions.

When the first temperature exceeds the first heat threshold value, the controller 110 proceeds to step 603. When the first temperature does not exceed the first heat threshold value, the controller 110 proceeds to step 604.

When the first temperature exceeds the first heat threshold value, the user may be harmed or the heat source may be damaged or malfunctions, and thus, the temperature of the heat source area may be relatively quickly lowered. Therefore, in step 603, the controller 110 preferentially processes the operation of lowering the temperature of the heat source area instead of other processes performed in the portable terminal (for example, the CPU 111, the oscillator 114, the communication module 120, and the like).

In step 604, the controller 110 determines whether the second temperature measured by the second temperature sensor 145 exceeds the second heat threshold value. When the second temperature exceeds the second heat threshold value, the user may be harmed or a component of the portable terminal apparatus 100 (for example, the input/output module 130, the power supplier 160, and the like) disposed in the external area of the heat source may be damaged or malfunction, and thus, the temperature of the external area be lowered. Therefore, in step 605, the controller 110 may process an operation of lowering a temperature of the component (for example, the input/output module 130, the power supplier 160, and the like) disposed in the external area.

When the first temperature does not exceed the first heat threshold value, and the second temperature also does not exceed the second heat threshold value, step 606 may be performed. In step 606, the controller 110 calculates a difference between the first temperature and the second temperature. For example, the difference between the first temperature and the second temperature may be calculated by subtracting the second temperature from the first temperature, which are input after being converted into digital values.

In step 607, the controller 110 determines whether the difference between the first temperature and the second temperature exceeds a predetermined threshold value (hereinafter, “difference threshold value”). The difference threshold value may be set based on a level in which the user may feel uncomfortable using the portable terminal apparatus 100 due to a difference between a temperature (the first temperature) of the heat source area of the portable terminal apparatus 100 and a temperature (the second temperature) of the external area. When the difference between the first temperature and the second temperature exceeds the difference threshold value, the controller 110 proceeds to step 608.

When the difference between the first temperature and the second temperature does not exceed the difference threshold value, the difference between the first temperature and the second temperature is maintained in a range where the user does not feel uncomfortable in using the portable terminal apparatus 100, and thus, the controller 110 may not separately control an operation of the heat source contained in the portable terminal apparatus 100 and may proceed to a process that repeatedly performs the operations described above (steps 601 through 606), in step 607.

In step 608, the controller 110 may control an operation of a corresponding heat source to lower heat generated from the heat source (for example, the CPU 111, the oscillator 114, the communication module 120, and the like). For example, the controller 110 may control a clock in a baseband of the communication unit 120, may control generation of a clock of the oscillator 114 that supplies a clock signal to the CPU 111, or may control a process of an application that has been driven by the controller 110, so as to control heat generated from the heat source area.

In step 609, the controller 110 may repeatedly perform steps 601 through 608 until an operation of controlling a temperature is completed.

It will be appreciated that the embodiments of the present invention may be implemented in a form of hardware, software, or a combination of hardware and software.

The software may be stored as program instructions or computer readable codes executable on the processor on a computer-readable medium. Examples of the computer readable recording medium include magnetic storage media (e.g., ROM, floppy disks, hard disks, etc.), and optical recording media (e.g., CD-ROMs, or DVDs). The computer readable recording medium can also be distributed over network coupled computer systems so that the computer readable code is stored and executed in a distributed fashion. This media can be read by the computer, stored in the memory, and executed by the processor. The text enlarging method of the present invention may be implemented by a computer or portable terminal including a controller and a memory, and the memory may be an example of the computer readable recording medium suitable for storing a program or programs having instructions to implement the embodiments of the present invention. The present invention may be implemented by a program having codes for embodying the apparatus and method described in claims, and the program being stored in a machine (or computer) readable storage medium. The program may be electronically carried on any medium, such as communication signals transferred by wired or wirelessly, and its equivalent.

The portable terminal may receive and store the program from a program provider connected by wire or wirelessly thereto. The program provider may include a memory for storing a program having instructions to carry out the method, information required for the method, a communication unit for conducting wired or wireless communication, and a controller for controlling transmission of the program. The program provider may provide the program to the portable terminal by wired or wirelessly at request of the portable terminal. The program provider may also provide the program to the portable terminal by wired or wirelessly even without request from the portable terminal, e.g., if the portable terminal is located within a particular range.

While the present invention has been particularly shown and described with reference to certain embodiments thereof, it will be understood by those of ordinary skill in the art that various changes in form and details may be made therein without departing from the spirit and scope of the present invention as defined by the following claims.

What is claimed is:

1. A method of controlling a temperature of a terminal apparatus, the method comprising:
measuring a first temperature of a heat source area where at least one heat source is included in the terminal apparatus, and measuring a second temperature of an external area that is distant from the heat source area;
determining a difference between the first temperature and the second temperature; and
controlling heat generated from the heat source, based on the difference between the first temperature and the second temperature.

2. The method of claim 1, wherein the first temperature is measured by at least one first temperature sensor placed close to the heat source.

3. The method of claim 1, wherein the second temperature is measured by at least one second temperature sensor placed in the external area so that the measurement is not affected by the heat generated from the heat source.

4. The method of claim 1, wherein controlling the heat generated from the heat source comprises:
determining whether the difference between the first temperature and the second temperature exceeds a predetermined difference threshold value;
controlling the heat generated from the heat source, when the difference between the first temperature and the second temperature exceeds the predetermined difference threshold value.

5. The method of claim 1, wherein controlling the heat generated from the heat source comprises:
determining whether the difference between the first temperature and the second temperature exceeds a difference threshold value predetermined in stages;
determining a heat control level for the heat source by determining whether the difference exceeds the difference threshold value predetermined in stages; and
controlling the heat generated from the heat source based on the determined heat control level.

6. The method of claim 1, wherein controlling heat generated from the heat source comprises:
determining whether the first temperature exceeds a predetermined heat threshold value; and
controlling the heat generated from the heat source, when the first temperature exceeds the predetermined heat threshold value.

7. The method of claim 1, wherein controlling the heat generated from the heat source comprises:
determining whether the first temperature exceeds a predetermined first heat threshold value;
controlling heat generated from the heat source when the first temperature exceeds the predetermined first heat threshold value;
determining whether the second temperature exceeds a predetermined second heat threshold value; and
controlling the heat generated from the heat source, when the second temperature exceeds the predetermined second heat threshold value.

8. The method of claim 7, wherein controlling the heat generated from the heat source when the first temperature exceeds the first heat threshold value comprises:
controlling the heat generated from the heat source by giving priority consideration to lowering the first temperature.

9. The method of claim 7, wherein controlling the heat generated from the heat source when the second temperature exceeds the second heat threshold value comprises:
controlling the heat generated from the heat source by giving priority consideration to a necessary operation of the heat source.

10. A terminal apparatus, comprising:
at least one processor;
a first temperature sensor that measures a first temperature of a heat source area where at least one processor is contained;
a second temperature sensor that measures a second temperature of an external area that is distant from the heat source area;
a memory that stores at least a temperature control program; and
a terminal housing that includes the at least one processor, the first temperature sensor, and the memory,
wherein the temperature control program is operated by the at least one processor, and includes an instruction that controls heat generated from the heat source based on a difference between the first temperature and the second temperature.

11. The terminal apparatus of claim 10, wherein the second temperature sensor is placed in the external area so that the measurement is not affected by the heat generated from the heat source, and measures the second temperature of the external area.

12. The terminal apparatus of claim 10, wherein the temperature control program comprises:
an instruction to determine whether the difference between the first temperature and the second temperature exceeds a predetermined difference threshold value, and to control heat generated from the heat source when the difference between the first temperature and the second temperature exceeds the predetermined difference threshold value.

13. The terminal apparatus of claim 10, wherein the temperature control program comprises:
an instruction to determine whether the difference between the first temperature and the second temperature exceeds a threshold value predetermined in stages, to determine a heat control level for the heat source by determining whether the difference exceeds the threshold value predetermined in stages, and to control heat generated from the heat source based on the determined heat control level.

14. The terminal apparatus of claim 10, wherein the temperature control program comprises:
an instruction to determine whether the first temperature exceeds a predetermined heat threshold value, and to control heat generated from the heat source when the first temperature exceeds the predetermined heat threshold value.

15. The terminal apparatus of claim 10, wherein the temperature control program comprises:
an instruction to determine whether the first temperature exceeds a predetermined first heat threshold value, and to control heat generated from the heat source when the first temperature exceeds the first heat threshold value; and
an instruction to determine whether the second temperature exceeds a predetermined second heat threshold value, and to control heat generated from the heat source when the second temperature exceeds the second heat threshold value.

16. The terminal apparatus of claim 15, wherein the instruction that controls the heat generated from the heat source when the first temperature exceeds the first heat threshold value, comprises:
an instruction that controls heat generated from the heat source by giving priority consideration to lowering of the first temperature.

17. The terminal apparatus of claim 15, wherein the instruction that controls the heat generated from the heat source when the second temperature exceeds the second heat threshold value, comprises:
an instruction that controls heat generated from heat source by giving priority consideration to a necessary operation of the heat source.

18. The terminal apparatus of claim 10, wherein the heat sources comprises at least one of an application processor, a communication processor, and an oscillator.

19. The terminal apparatus of claim 10, wherein the second temperature sensor is contained in an internal space in the terminal housing.

20. The terminal apparatus of claim 10, wherein the second temperature sensor is contained in an external case attached to the outside of the terminal housing, and includes a communication interface that transfers, to the at least one processor, data provided from the second temperature sensor.
